(19) United States
(12) Patent Application Publication
(10) Pub. No.: US 2026/0288730 A1
(43) Pub. Date: Sep. 24, 2026

(54) METHOD AND SYSTEM FOR PARTITIONING DATA RECORDS FOR A JOIN OPERATION

(71) Applicant: Sindice Limited, Galway (IE)

(72) Inventors: Stephane CAMPINAS, Berlin (DE); Matteo MATTEO, Citta Sant'Angelo (IT); Renaud DELBRU, Gradignan (FR)

(21) Appl. No.: 19/475,251

(22) PCT Filed: Apr. 14, 2023
(86) PCT No.: PCT/EP2023/059801

§ 371 Date: Oct. 14, 2025

(51) Int. Cl. G06F 16/2455

(52) U.S. Cl. CPC G06F 16/2456; G06F 16/24552; G06F 16/24554

(57) ABSTRACT

In a distributed shared-nothing database, data records are partitioned for a join operation prior to being sent to individual computing instances. Each data table of the left relation to be joined is assigned to an equivalence class where members of an equivalence class each rely on partitioning functions that result in the same partitioning of records. Each record of the right relation is mapped to a partition of the equivalence class avoiding duplication where the record belongs to multiple tables of that equivalence class. Records are then grouped by computing instance and sent, as a tuple identifying the record and the equivalence class partition, to each computing instance hosting a table of the equivalence class. At the computing instance, the equivalence class partition is resolved to assign the record to the corresponding partitions of the data tables hosted on that computing instance to thereby permit a join operation.

### TECHNICAL FIELD

The present invention relates to the field of databases, and, in particular, to the efficient partitioning of records for join operations in a distributed shared-nothing database.

### BACKGROUND ART

A distributed database system can be based on a shared-nothing architecture (O'Neil, Patrick, et al. “The log-structured merge-tree (LSM-tree).” Acta Informatica 33.4 (1996): 351-385), which can be a key-value store, a document store, a graph store or a columnar data store. Many modern databases such as Apache Cassandra (trade mark of Apache Software Foundation) described in Lakshman, Avinash, and Prashant Malik. “Cassandra: a decentralized structured storage system.” ACM SIGOPS Operating Systems Review 44.2 (2010): 35-40; Bigtable (trade mark of Google LLC) described in Chang, Fay, et al. “Bigtable: A distributed storage system for structured data.” ACM Transactions on Computer Systems (TOCS) 26.2 (2008): 4; Apache HBase (trade mark of Apache Software Foundation); and Elasticsearch (trade mark of Elasticsearch BV) are based on this type of architecture.

In a shared-nothing distributed database architecture, the database system runs on a cluster of computing nodes (also referred to herein as computing instances) in which each computing node is independent from the other. The data collection is partitioned and distributed across the nodes. A data table is logically divided into one or more non-overlapping data table partitions, also called data table shards. Each node can have one or more data table shards that are themselves independent from each other. A data table shard can be replicated over one or more nodes to handle failover scenarios. References herein to computing instances hosting data tables and table partitions, and to systems composed of such instances, also embrace such systems in which replication mechanisms exist to replicate data across different instances.

Distributed database systems are used to manage, query and analyze data at scale. One of the most important operations is the join which is used to retrieve and combine data from two different datasets based on a logical relationship such as an equality on a set of attributes. While there has been significant progress on how to efficiently execute a join operation in a distributed scenario, important challenges remain due to the nature of the distributed database architecture. A distributed join operation can be decomposed into two stages: a data exchange stage where the data is distributed into one or more partitions and transferred across the computing nodes of the cluster, and a local join stage where the data partitions are joined locally on each computing node. The exchange stage usually incurs a heavy network cost due to the amount of data transferred. Designing new methodologies to optimize the exchange stage is therefore key to improve the performance of the distributed join operation.

In Polychroniou, Orestis, Rajkumar Sen, and Kenneth A. Ross. “Track join: distributed joins with minimal network traffic.” Proceedings of the 2014 ACM SIGMOD international conference on Management of data. 2014, the authors present a distributed join algorithm that takes into consideration the location of records in a cluster, and applies a cost optimization function to lower the network cost of a join. The approach differs from the present disclosure in two ways. Firstly, the algorithm in Polychroniou et al. doesn't consider relations of the join to be composed of several tables. The consequence is that records are duplicated between tables, thus increasing the network cost of the join. The Strategy S1 is a representation of that scenario. The equivalence relation presented in this disclosure is a necessary concept to handle the case where relations of the join are composed of several tables. Secondly, the cost optimization proposed in Polychroniou et al. is applied at the key-level, rather than at the table partition-level. Indeed, a key of either side of the join can be broadcast to the other side, independently of where other keys of the relation got sent to. This requires a cardinality histogram to be available for each key of both sides of the join, which can be costly to create and manage.

### DISCLOSURE OF THE INVENTION

In one aspect, there is provided a method for partitioning a plurality of data records for a join operation on a join key between a left relation and a right relation in a distributed shared-nothing database environment comprising a plurality of computing instances, wherein:

the left relation comprises a plurality n of data tables {t₁, t₂, . . . tₙ}, each comprising a respective set of records and each being partitioned on the join key according to a respective table partitioning function {fₜ_{₁}, fₜ_{₂}, . . . fₜ_{ₙ}}, wherein the table partitions are hosted on respective computing instances;
the right relation comprises the plurality of data records r to be partitioned on the join key;
the method comprising the steps of:
a. sharing between the computing instances a set of equivalence classes {c₁, c₂, . . . cₘ}, each equivalence class comprising a plurality d of equivalence class partitions p_{c,i} where 1≤i≤d and each equivalence class identifying a subset of the plurality n of data tables {t₁, t₂, . . . tₙ} which are partitioned according to equivalent partitioning functions; wherein two partitioning functions fₜ and fᵤ of data tables t and u are equivalent if for each record r, fₜ(r) assigns the record to a table partition p_{t,i} of table t with index i and fᵤ(r) assigns the record to a table partition p_{u,j} of table u with index j, where i=j and 1≤i, j≤d; whereby table partition p_{t,i} of table t and table partition p_{u,j} of table u are each mapped to an equivalence class partition p_{c,i} of an equivalence class c ∈{c₁, c₂, . . . cₘ} identifying tables t and u;
b. for each record r of the right relation, and each table t of the left relation in which the record r may appear, mapping the record to a respective equivalence class partition p_{c,i} of the equivalence class c identifying the table t, and removing duplicate instances of records mapped to a given equivalence class partition p_{c,i}, to produce a collection of unique tuples <r, p_{c,i}>;
c. identifying, for each equivalence class partition p_{c,i} identified in one of the tuples <r, p_{c,i}>, one or more associated computing instances hosting the equivalent table partition(s) p_{t,i} of the left relation table(s) t identified in the equivalence class c;
d. grouping the tuples <r, p_{c,i}> by their associated computing instance(s);
e. sending, to each associated computing instance, the records with which the computing instance is associated, wherein each record is accompanied by an identifier of the or each equivalence class partition to which it has been mapped.

The method uses an intermediate data representation consisting of groups of equivalent table partitions instead of table partitions during the exchange of records between computing instances. If a record is found in multiple table partitions hosted on a remote computing instance, and those table partitions are the result of equivalent partitioning functions, then rather than sending over the network multiple indications of the record and its location within table partitions, a single indication of the equivalence class partition can be sent, and this can then be resolved locally at the remote computing instance to find the hosted table partitions of the tables in that equivalence class into which the record would have been partitioned, such as with a simple lookup. This reduces the amount of data sent to a computing unit, decreasing the network and memory cost as well as CPU cost due to having less data to process.

In one embodiment, the grouping step (d) further comprises grouping said equivalence class partitions p_{c,i} per record; and the sending step (e) comprises sending a unique instance of each record, accompanied by an identifier of the or each equivalence class partition to which it has been mapped.

This has the advantage that it provides a further reduction in network cost by reducing the amount of duplicated data sent to the computing units in the final step.

For example, such as in Strategy S6 described further below, incoming tuples are grouped on a per node basis and then per record, with the resulting group of tuples then transferred to their respective computing units. The receiving computing units can then scan the incoming tuples to resolve the appropriate table partitions for the local join computation.

In another embodiment, the sending step (e) comprises sending, for each equivalence class partition to which a record has been mapped, a copy of the record with an identifier of that equivalence class partition.

The method preferably further comprises performing a local join operation at each associated computing instance by:
mapping the identifier of an equivalence class partition associated with a received record to one or more equivalent table partitions hosted on the computing instance;
performing a local join operation between said one or more equivalent table partitions hosted on the computing instance and records of the right relation received by the computing instance in step (e).

It can be seen that the improvements in the partitioning of records also results in a more efficient join operation due to the reduction in the amount of duplicated data which provides a reduction in CPU cost (less data to scan/process).

Preferably, each table of the left relation is identified uniquely in a single equivalence class of the set of equivalence classes.

In preferred embodiments, the method further comprises:
maintaining a partitioning functions map which identifies, for each table {t₁, t₂, . . . tₙ} of the left relation, the respective table partitioning function {fₜ_{₁}, fₜ_{₂}, . . . fₜ_{ₙ}}; and sharing said partitioning functions map across the computing instances.

This provides an efficient tool for the creation of equivalence classes.

Preferably, the method further comprises:
generating said equivalence classes by identifying equivalent table partitioning functions in the partitioning functions map and grouping together in an equivalence class each table having equivalent table partitioning functions.

The identification of equivalent table partitioning functions can be implemented by, for example, using object oriented programming and providing an equality method for partitioning function objects that compares two objects by their attributes. Alternatively, partitioning functions can be selected from a predefined list, with known equivalence between different functions on the list. As a further alternative, an analysis of the functions themselves can reveal whether they are equivalent.

Preferably, the method further comprises:
maintaining an equivalent partitions map which identifies, for each equivalence class, the equivalence class partitions of that class; and
sharing said equivalent partitions map across the computing instances.

Such a map can be used both when mapping a record to an appropriate equivalent partition, and when resolving an equivalence class partition to the corresponding table partitions at a computing instance performing a local join operation.

Preferably, the identifier of the or each equivalence class partition sent to the computing instances in step (e) points to an entry in the equivalent partitions map.

For example an ordinal value can be used to identify the position of the equivalence class partition in an equivalent partitions map that is maintained and shared as an ordered collection.

By identifying equivalence class partitions in this way, further reductions in network and memory cost are obtained.

Preferably, each associated computing instance receiving a record as a result of step (e) identifies the hosted table partitions p_{t,i} of the left relation in which the record may be located by:
determining from the received identifier(s) of each equivalence class partition p_{c,i} the associated data tables of the equivalence class c to which the equivalence class partition p_{c,i} belongs; and identifying for each associated data table the table partitions p_{t,i} having a one-to-one correspondence with the equivalence class partition p_{c,i}.

Preferably, the method further comprises:
maintaining a hosting function map which identifies, for each table partition, the or each associated computing instance hosting that table partition; and
sharing said hosting function map across the computing instances.

Such a hosting map can be used to reduce the transfer of data across the network, by revealing which computing instances host a given partition and therefore should receive records that belong to that partition.

Preferably, the identifying step (c) comprises:
identifying, for each equivalence class partition p_{c,i} identified in one of the tuples <r, p_{c,i}>, the equivalent table partition(s) p_{t,i} of the left relation table(s) t identified in the equivalence class c; and
determining, from the hosting function map, the or each associated computing instance hosting that table partition.

It is to be noted that while a specific partition (e.g., partition 1 of table customer_asia) is generally hosted by only one computing instance, the partitions of an equivalence class may include partitions of more than one table (e.g. partition 1 of table customer_asia and partition 1 of table customer_eu if they are equivalent). Therefore a given partition of an equivalence class may encompass partitions of different tables hosted on different computing instances (e.g. if partition 1 of customer_asia is on node x and partition 1 of customer_eu is on node y).

Preferably, the mapping step (b) comprises:
for each record r of the right relation, and each data table t of the left relation in which the record r may appear, applying the partitioning function record fₜ of the data table t to assign the record to a table partition p_{t,i} of the data table t;
determining, from the equivalence class c to which the data table t belongs, the corresponding equivalence class partition p_{c,i}.

Alternatively, step (b) may comprise:
for each record r, caching an identification of the data tables in which the record may appear;
identifying a set of equivalence classes covering each data table in which the record may appear;
for each equivalence class in said set, applying a partitioning function which is equivalent to or identical to the partitioning function of one of the data tables of that equivalence class; and
determining the corresponding equivalence class partition p_{c,i}.

The steps of caching and identifying above refer to data tables in which a record may appear. Before the join operation it may be unknown if a record from the right has a match in a table from the left. Therefore while it is known which tables a record may appear in, it is only after the join that it is determined whether there is in fact a match with a record in such tables.

Preferably, one or more of steps (b), (c), (d) and (e) are performed in batched operations, handling a plurality of records per step at one time.

There is also provided a distributed computing system providing a distributed shared-nothing database environment, comprising:
a plurality of computing instances connected over a network, at least some of which host data records of a left relation and a right relation of a database, wherein:
the left relation comprises a plurality n of data tables {t₁, t₂, . . . tₙ}, each comprising a respective set of records and each being partitioned on the join key according to a respective table partitioning function {fₜ_{₁}, fₜ_{₂}, . . . fₜ_{ₙ}}, wherein the table partitions are hosted on respective ones of said computing instances;
the right relation comprises the plurality of data records r to be partitioned on the join key;
said computing instances are programmed to co-operatively perform a method for partitioning a plurality of data records for a join operation on a join key between said left relation and said right relation, according to the methods disclosed and claimed herein.

There is also provided a computer program product comprising instructions for execution by one or more computing instances of a distributed computing system providing a distributed shared-nothing database environment, in which:
a plurality of said computing instances are connected over a network, at least some of which host data records of a left relation and a right relation of a database, wherein:
the left relation comprises a plurality n of data tables {t₁, t₂, . . . tₙ}, each comprising a respective set of records and each being partitioned on the join key according to a respective table partitioning function {fₜ_{₁}, fₜ_{₂}, . . . fₜ_{ₙ}}, wherein the table partitions are hosted on respective ones of said computing instances;
the right relation comprises the plurality of data records r to be partitioned on the join key;
wherein said instructions when executed by one or more of said computing instances cause said computing instances to co-operatively perform a method for partitioning a plurality of data records for a join operation on a join key between said left relation and said right relation, by taking the steps of one of the methods disclosed and claimed herein.

### BRIEF DESCRIPTION OF THE DRAWINGS

The invention will now be further illustrated by the following description of embodiments thereof, given by way of example only with reference to the accompanying drawings, in which:

FIG. 1 is a block diagram of a distributed computing system;

FIG. 2 is an example of a database query;

FIG. 3 is an example of a distributed query execution plan generated from the database query of FIG. 2;

FIG. 4 is a representation of the execution of the database query of FIG. 2;

FIG. 5 is a representation of a join operation with co-partitioned tables on the joined key;

FIG. 6 is a representation of a join operation with partially partitioned tables on the joined key;

FIG. 7 is a representation of a join operation with non-partitioned tables on the joined key;

FIG. 8 is a representation of applying a partitioning function to a Customers table;

FIG. 9A is a representation of a partitioning function map;

FIG. 9B is a representation of a table equivalence classes map;

FIG. 9C is a representation of an equivalent partitions map;

FIG. 10 is a flowchart of a method of partitioning a table in a distributed shared-nothing environment;

FIG. 11 is a representation of the hosting of table partitions on different computing nodes and of a corresponding hosting function map;

FIG. 12 is a schematic representation of applying a partitioned function of a left relation (Customers) over a right relation (Orders) where the left relation comprises records of a single table or single table view;

FIG. 13 is a schematic representation of applying a partitioned function of a left relation (Customers) over a right relation (Orders) where the left relation comprises records of several data tables;

FIG. 14 is a flowchart of a method of partitioning a left relation in a distributed shared-nothing environment according to a first strategy S1;

FIG. 15 is a pseudocode implementation of the partitioning stage of a second strategy S2;

FIG. 16 is a pseudocode implementation of the partition identifier stage of strategy S2;

FIG. 17 is a pseudocode implementation of the hosting stage of strategy S2;

FIG. 18 is a flowchart of a method of partitioning a left relation in a distributed shared-nothing environment according to strategy S2;

FIG. 19 is a flowchart of a method of partitioning a left relation in a distributed shared-nothing environment according to a third strategy S3;

FIG. 20 is a flowchart of a method of partitioning a left relation in a distributed shared-nothing environment according to a fourth strategy S4;

FIG. 21 is a flowchart of a method of partitioning a left relation in a distributed shared-nothing environment according to a fifth strategy S5;

FIG. 22 is a flowchart of a method of partitioning a left relation in a distributed shared-nothing environment according to a sixth strategy S6;

FIG. 23 is a flowchart of operation of a node coordinator on receiving a database query; and

FIG. 24 is a pseudocode implementation of the strategy selection method.

### DETAILED DESCRIPTION OF PREFERRED EMBODIMENTS

Disclosed herein are methods which may be implemented in computing systems and/or computer program products.

The various computing instances described herein are typically implemented via hardware or firmware as will be appreciated by a person of skill in the art. Each of the computing instances may be provided as one or more processes or threads, running on one or more processors, in one or more computing devices, executing computer program instructions and interacting with other system components for performing the various functionalities described herein.

A person of skill in the art should recognize that a computing device may be implemented via firmware (e.g., an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention.

The various computing instances may be located on the same or different computing devices, at the same or different physical locations (or in the cloud) e.g., in a remote data center, and may be connected to one another via a network such as the Internet. The typical scenario is to have different computing instances as different physical computing devices, each with access to its own data stores, and each connected over a private or public network.

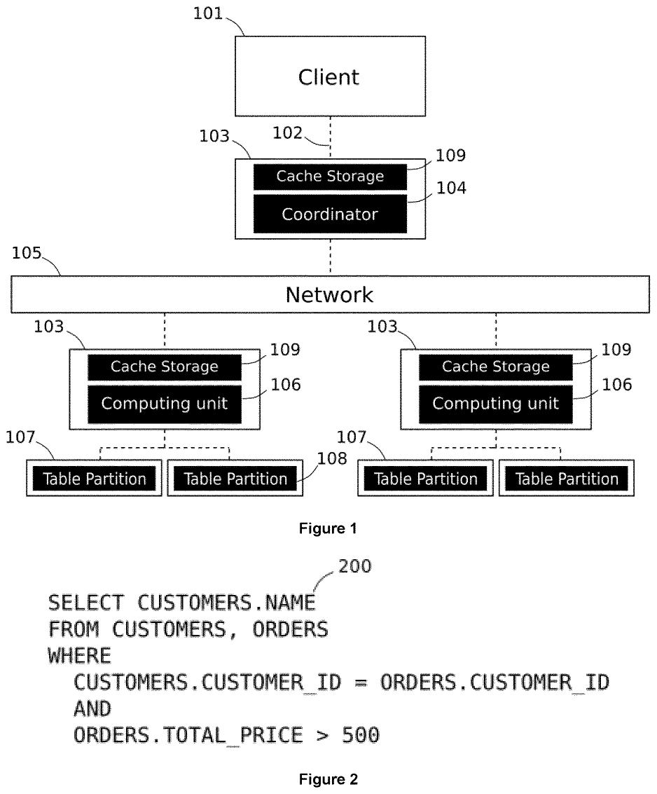

FIG. 1 illustrates an exemplary computer system, according to an embodiment of the present disclosure. The computer system comprises one or more nodes 103. A node is a database system process which includes computer-readable program instructions to carry out aspects of the present disclosure. For example, a node may include instructions to carry out the necessary functions of a coordinator 104 or of a computing unit 106. Nodes may include one or more cache storage areas 109. Nodes may be interconnected by a network 105. One or more computer-readable storage media 107 may be attached to a computing unit node. One or more data table partitions 108 may be stored on a computer-readable storage medium. A computing unit node may carry out various functions such as but not limited to maintenance operations on the table partitions, scanning table partitions, transferring data to other computing unit nodes, executing join operations. A client 101 may interact with the computer system through the coordinator node by sending a query 102.

The computer program product may include a computer-readable storage medium (or media) having computer-readable program instructions thereon for causing a processor to carry out aspects of the present disclosure. Examples of computer-readable storage medium include, but are not limited to: magnetic media such as hard disks, floppy disks and magnetic tape; optical media such as CD-ROMs and DVDs; and hardware devices such as ROM or RAM. Examples of computer-readable program instructions include machine instructions such as produced by a compiler and higher-level instructions that are interpreted by another computer program.

Any distributed database system based on shared-nothing architecture, which can be for example a key-value store, a document store, a graph store or a columnar data store that perform join operations, may benefit from the present disclosure. In particular, the present disclosure can be beneficial for data analytics platforms based on such distributed database systems in domains including but not limited to business intelligence, operational intelligence, data investigation, security information and event management, log analysis, and so on. The join operations may be used, for example, to correlate records from different tables, create views by joining multiple tables into a single table, and support relational navigation techniques such as “relational drill down” and data exploration in relational faceted systems. For example, the present disclosure may be used in data investigation platforms to reduce latency and cluster load in operations such as relational navigation between dashboards, computing views by joining multiple tables, alerting on complex relational queries, correlating a large number of records into a graph representation, and so on.

### Distributed Execution of a Join Operator

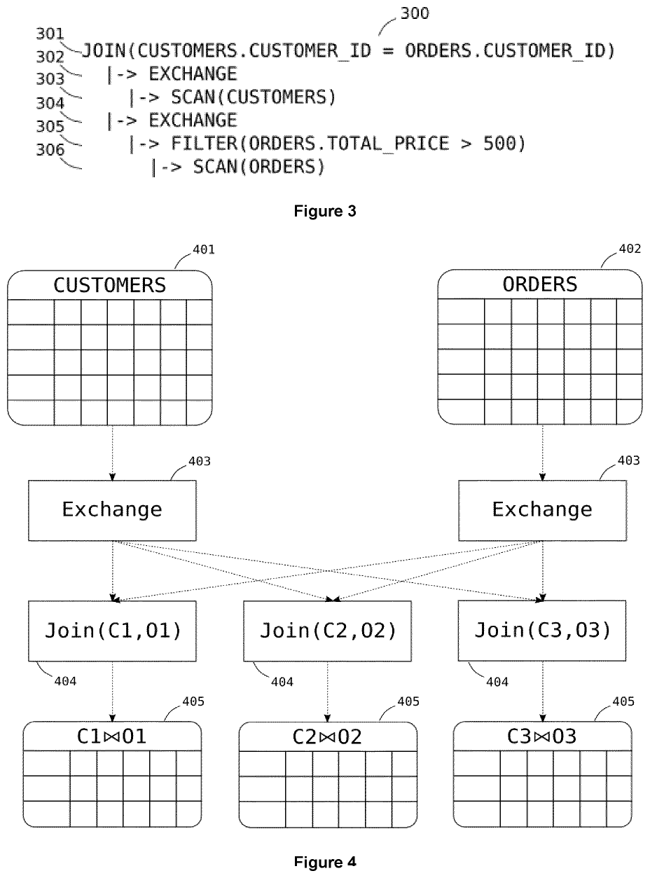

FIG. 2 illustrates a query example 200 that retrieves the names of all customers who have made an order with a total price over 500. Records from the CUSTOMERS table are filtered based on the records from the ORDERS table. FIG. 3 illustrates a distributed query execution plan 300 that has been generated from the query example 200 of FIG. 2. The query execution plan includes a join operator 301 with a condition on the CUSTOMER_ID attribute. The join operator has two children exchange operators, 302 and 304, which encapsulate data distribution instructions. Each exchange operator has a single child, a scan operator of the CUSTOMERS table for the left hand side 303, and a filter operator with a condition on the TOTAL_PRICE attribute for the right hand side 305. The filter operator has a single child operator; a scan operator of the ORDERS table 306.

A join is a binary operator taking two relations as inputs, called the left and right relations, and producing one relation as output. A relation may be a data table stored on disk or in memory, an intermediate data table created by the database to store temporary data that is used to calculate the final result set (e.g., the relation output of another query operator), or a logical view over one or more relations. The output of a join is an intermediate data table composed of all possible combinations of records from both the left and right relations which satisfy the join condition.

In a distributed, shared-nothing environment, the exchange operator is used to introduce parallelism between computing units and within a computing unit, which may have one or more worker threads. Worker threads operate independently of each other and communicate via the exchange operators. For the sake of clarity of exposition, we here assume that each computing unit owns a single worker thread. However, the present method can be applied in any multithreading scenario.

The exchange operator distributes its input into one or more partitions, based on a partitioning function and a partitioning key (which may be based on one or more columns), and transfers them to their respective worker threads. Each worker thread can then perform a local join operation based on the partitions it received.

FIG. 4 is a representation of the distributed query execution. The CUSTOMERS table 401 and the ORDERS table 402 are distributed into 3 partitions each (C1, C2 and C3 for the CUSTOMERS table, and O1, O2 and O3 for the ORDERS table) via the exchange operator 403 across multiple worker threads 404. Each worker thread 404 executes a local join on a partition and produces a subset of the table output 405. The union of subsets 405 produces the final output for CUSTOMERS [symbol] ORDERS, each subset being disjoint. The exchange operation may be performed using different data distribution strategies, for example, a round robin, a hash partitioning, a range partitioning or a broadcast strategy. The local join operation may be performed using a hash join strategy, a sort-merge join strategy, an index join strategy or any other join strategy.

The selection of the appropriate exchange and local join strategy is critical for achieving optimal performance. The exchange operator may induce a heavy network cost which depends on the amount of data being transferred across the network. The coordinator is responsible for selecting the appropriate physical implementation using a cost-based analysis. Such an analysis must take into account the partitioning of the data tables which can be classified into three main scenarios: tables co-partitioned on the joined key, tables partially partitioned on the joined key and tables non-partitioned on the joined key.

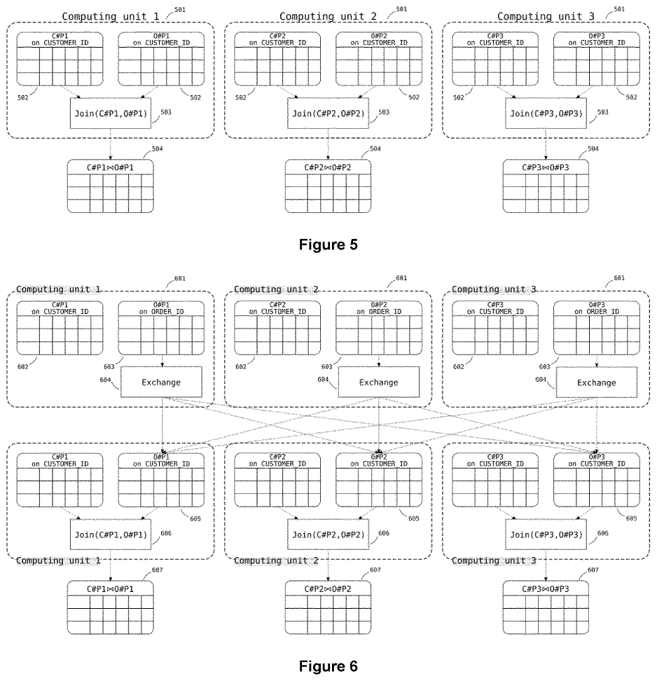

FIG. 5 represents the scenario with co-partitioned tables on the joined key. Both the CUSTOMERS and ORDERS tables are partitioned on the joined key column CUSTOMER_ID. This leads to data table partitions 502 that are co-located on each computing unit 501. For example, the partition C#P1 from the CUSTOMERS table and the partition O#P1 from the ORDERS table are co-located on the computing unit 1. In that scenario, the exchange phase is skipped, eliminating any network cost, and the local join phase 503 may be performed immediately to produce the table output 504.

FIG. 6 represents the scenario with partially partitioned tables on the joined key, where only the CUSTOMERS table 602 is partitioned using the joined key column CUSTOMER_ID, whereas the ORDERS table is partitioned on the column ORDER_ID 603. In that scenario, it is beneficial to reuse the table partitions C#P1, C#P2 and C#P3 of the CUSTOMERS table 602, hereby skipping the exchange phase on this table, and to apply the exchange operator 604 on the table partitions O#P1, O#P2 and O#P3 of the ORDERS table 603 to repartition them using the joined key column CUSTOMER_ID. This leads to data table partitions from the CUSTOMERS table 602 and from the ORDERS table 605 that are co-located on each computing unit 601. A local join phase 606 is then performed on the co-partitioned table partitions to produce the table output 607. The network cost is bound to the size of the ORDERS table.

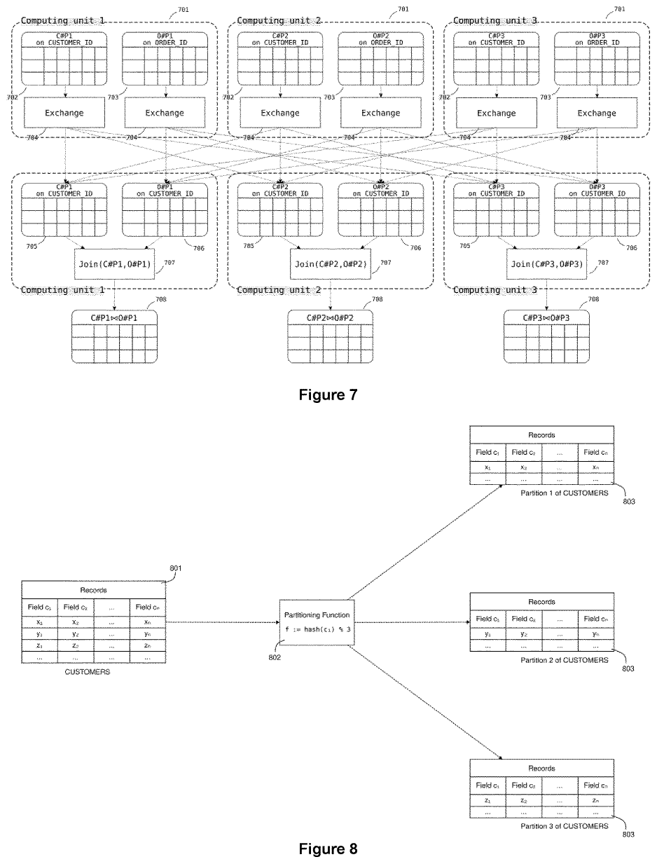

FIG. 7 represents the scenario with non-partitioned tables on the joined key. Both the CUSTOMERS 702 and ORDERS 703 tables must be partitioned on the join key column CUSTOMER_ID before being able to perform the local join phase. An exchange operator 704 is applied on the table partitions C#P1, C#P2 and C#P3 of the CUSTOMERS table 702 and on the table partitions O#P1, O#P2 and O#P3 of the ORDERS table 703 to repartition them using the joined key column CUSTOMER_ID. This leads to data table partitions from the CUSTOMERS table 705 and from the ORDERS table 706 that are co-located on each computing unit 701. A local join phase 707 is then performed on the co-partitioned table partitions to produce the table output 708. This operation may incur a significant network cost given that both tables must be transferred across the network. In an embodiment, one may apply a single exchange operator on the smallest table using a broadcast strategy in order to reduce the network cost.

The present disclosure relates to methodologies for optimizing the network cost of the exchange operator for the scenario with partially partitioned tables on the joined key.

### Partitioning Function of a Table

The partitioning function of table tis a function fₜ(r) that, given a record r and a table t, returns partition p_{t,i}, i.e., the i-th partition of table t. The number of partitions that fₜ returns coincides with the number d of partitions of t, which is finite. That is fₜ(r)=p_{t,i} such that 1≤i≤d.

Given a function fₜ, it is known how many partitions d it can return. In an embodiment, this is possible by representing the function as an object with a method implementing the function itself and an attribute holding the value of d.

In an embodiment, a partitioning function can use a hashing function to hash the value of one or more fields of record r, and then compute the hash value modulo the desired number d of partitions for table t. The partitioning function would then associate the record r to the i-th partition of table t as returned by the modulo.

In another embodiment, the domain of one or more record fields is split into a number of ranges equal to the desired number d of the partitions for table t, so that each range is associated with a partition. The partitioning function would take the fields' values of r as input, and determine to which i-th range they belong. The partitioning function would then associate the record r to the i-th partition of table t.

Partitioning functions can be used in various database operations. For example, when inserting a record r in table t, the partitioning function fₜ can be used to select into which partition of t the records must be stored. When searching for the existence of a record r in table t, the partitioning function fₜ indicates which partition p_{t,i} the record r must be searched in.

For these reasons, the system must be capable of referring to partition p_{t,i} via a unique identifier. This can be implemented in various ways. For example, a partition identifier could be a pair <t, i>, where t is a unique identifier of table t, and i is an ordinal value which identifies the i-th partition of the table.

As an example, in FIG. 8 we see the logical table CUSTOMERS 801 being partitioned into three table partitions 803. Partitioning happens using the partitioning function f 802 which applies the hashing function ‘hash ( )’ to the record field c₁, and the hash value modulo the desired number of the partitions (i.e., three) is eventually computed.

Every computing unit in the cluster knows how each data table has been partitioned, i.e., which partitioning function has been used.

One preferred way of ensuring this (though not the only way) is that each computing unit hosts a “partitioning functions map” that associates each table to the partitioning function used to partition it.

The computing units may coordinate between themselves to maintain these shared maps using robust synchronization techniques such as Apache Zookeeper (trade mark of Apache Software Foundation), as described in Hunt, Patrick, et al. “{ZooKeeper}: Wait-free Coordination for Internet-scale Systems.” 2010 USENIX Annual Technical Conference (USENIX ATC 10). 2010.

### Equivalence of Table Partitions

We consider two partitioning functions fₜ and fᵤ to be equivalent, i.e., fₜ~fᵤ, if for each record r, fₜ(r)=p_{t,i} and fᵤ(r)=p_{u,j} and i=j.

Let R be the relation between tables of the system that have the same partitioning function, i.e., R={(t, u)∈T×T|fₜ~fᵤ} where T is the non-empty set of tables. R is an equivalence relation because it is reflexive, symmetric, and transitive. If (t, u) ∈ R×R then we say that t and u are equivalent according to R and we write t~_{R} u.

For each tablet ∈ T, the equivalence class [t] determined by ~_{R} is the subset of T that is equivalent to t. That is, [t]={x ∈T|x~_{R} t}. We denote the set of all the equivalence classes of T by T/~_{R}. For the sake of readability, and unless specified otherwise, in the following we will denote the equivalence class [t] with the symbol c (as in ‘equivalence class’). All the tables belonging to equivalence class c are partitioned into the same number of partitions dc.

Let Q be a relation on a non-empty set P of table partitions. Two table partitions p_{t,i} and p_{u,j} are equivalent by Q if t and u are equivalent according to R and i=j, i.e. Q={(p_{t,i}, p_{u,j}) ∈ P×P|t~_{R} u and i=}. Q is an equivalence relation because it is reflexive, symmetric, and transitive. If (p_{t,i}, p_{u,j}) ∈ Q×Q then we say that p_{t,i} and p_{u,j} are equivalent according to Q and we write p_{t,i}~Q p_{u,j}.

For each p_{t,i} ∈ P, the equivalence class [p_{t,i}] determined by ~Q is the subset of P that is equivalent to p_{t,i}. That is, [p_{t,i}]={y∈P|y~_{Q} p_{t,i}}. We denote [p_{t,i}] as p_{c,i} and call p_{c,i} the partition i of the equivalence class c.

We assume there exists a finite (although large) number of tables in the system, each partitioned into a finite number of partitions using a finite number of partitioning functions. Therefore there exists only a finite number of partitions p_{c,i} for an equivalence class c. It is then possible to have a function ord(p_{c,i}) that returns an ordinal representation of the partition p_{c,i}.

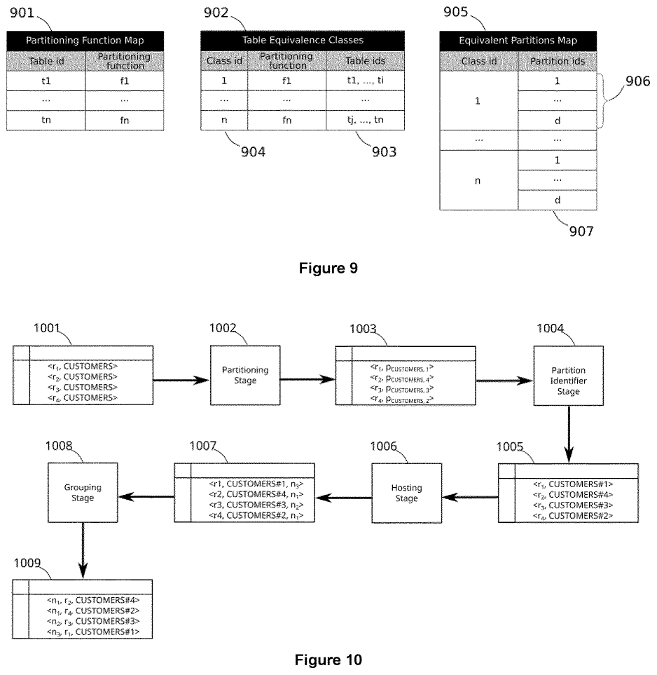

In an embodiment, as illustrated in FIG. 9, the equivalence relation between two tables may be achieved by fetching the associated partitioning function of each table from a partitioning functions map 901 stored in the cache storage of a computing unit, then checking if they are equivalent.

In an embodiment, the equivalence between partitioning functions may be implemented using object oriented programming using an equality method that compares two objects by their attributes.

In an embodiment, the set of equivalence classes T/~_{R} can be based on a data structure, denoted by “table equivalence classes” 902, mapping a partitioning function to a set of tables and stored in the cache storage of a computing unit.

This data structure can be built by scanning the partitioning function map 901 and by grouping the tables based on the equivalent partitioning functions. A set of tables 903 represents an equivalence class c and is composed of tables that have equivalent partitioning functions.

An ordinal value based on an incremental identifier may be assigned to each entry and may serve as class identifier 904.

In an embodiment, an “equivalent partitions map” 905 that maps an equivalence class c ∈ T/~_{R} to a list of partitions p_{c,i} for the equivalence class c may be stored in the cache storage of a computing unit.

The equivalent partitions map may be built by scanning the table equivalence classes data structure 902.

For each class identifier 904, the associated partitioning function is retrieved, and based on the number of partitions d a partitioning function can produce, a set of equivalence class partitions p_{c,i} 906 is derived.

An ordinal value based on an incremental identifier may be assigned to each equivalence class partition and may serve as partition identifier 907. The ordering of elements in the set must be kept consistent between computing units: this ensures that values associated to classes are the same regardless of the computing unit. For example, this can be achieved by sorting on the class identifier and on the partition index i, ranging from 1 to d.

### Exchange Operator

The exchange operator is responsible for sending records from a relation to a set of tables according to the partitioning functions of the said tables. For example, in the join of CUSTOMERS with ORDERS where the CUSTOMERS table is partitioned on the joined key CUSTOMER_ID, the exchange operator is responsible for transferring records of ORDERS to the partitions of CUSTOMERS.

The exchange operator is a sequence of stages applied over a relation, whose output is a list of partition identifiers and computing units to send a record to. The exchange operator is composed of the following stages:
1. The partitioning stage
2. The partition identifier stage
3. The hosting stage
4. The grouping stage

A record is passed through each stage that composes the exchange operator, with the output of a stage being the input of the next one in the sequence. The partitioning stage takes as input, for example, a tuple containing a table and a record, and associates a partition to the record.

In an embodiment, the associated partition can be a table partition. In another embodiment, it can be a partition of the equivalence class for the given table.

A unique identifier is then assigned to a partition using a partition identifier stage. A hosting stage then resolves the computing unit(s) on which a partition is located. Finally, a grouping stage is applied over a dimension of the input tuple.

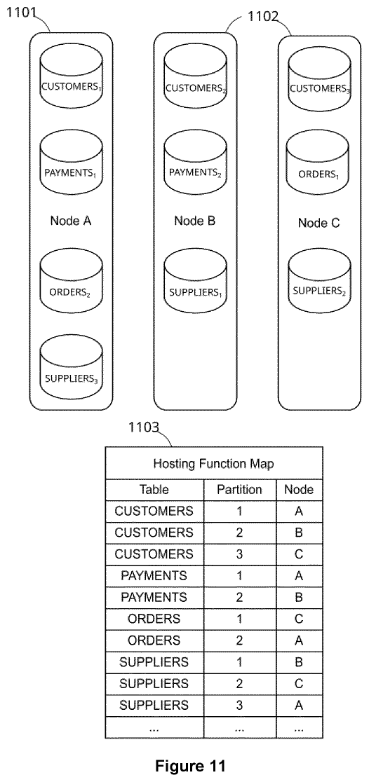

We run through the stages of the exchange operator in the following sections, depicted in FIG. 10, considering the case where the partitioning stage returns a partition table.

### The Partitioning Stage

A partitioning stage accepts as input a tuple composed of a record r and a table t. The associated table partitioning function of the table t is retrieved from the partitioning function map component 901, available in the cache storage of a computing unit. The partitioning function is applied on the record and produces a table partition p_{t,i}. The output of the partitioning stage is a tuple <r, p_{t,i}>.

As shown in FIG. 10, the partitioning function 1002 is applied on a list of tuples <r, t> 1001 and produces a list of tuples <r, p_{t,i}>1003.

### The Partition Identifier Stage

A partition identifier stage accepts as input a tuple composed of a record r and a table partition p_{t,i}. A function id( ) is applied to the partition p_{t,i} and produces an identifier id(p_{t,i}) that is unique in the cluster. The output of the partition identifier function is a tuple <r, id(p_{t,i})>.

In an embodiment, the function id( ) may be implemented by assigning to a table partition p_{t,i} a unique identifier composed of the table identifier t and of the partition ordinal i of that table. In another embodiment, the function id( ) may assign to a partition p_{t,i} a unique incremental integer based on an ordinal function ord(p_{t,i}). In another embodiment, the function id( ) may assign to a partition p_{c,i} a unique incremental integer based on an ordinal function ord(p_{c,i}), with c the equivalence class of t.

As shown in FIG. 10, the partition identifier stage 1004 is applied on a list of tuples <r, p_{t,i}>1003 and produces a list of tuples <r, id(p_{t,i})>1005. In the example, the function id( ) is implemented by concatenating the table identifier with the partition ordinal.

### The Hosting Stage

The hosting stage h(p_{t,i}) returns the computing unit identifier n that hosts the partition p_{t,i}. The hosting stage is needed whenever a computing unit n needs to communicate with a partition p, e.g., to upload records to partition p so that a join operation can be performed. In fact, the system needs to know which node m=h(p_{t,i}) hosts the partition p_{t,i}, so that a network communication link can be established between nodes n and m.

Each computing unit can know which node hosts a particular partition of a table. In an embodiment, this is possible as each computing unit holds a “hosting map” in its cache storage that associates each data partition of each table to the computing unit that hosts it. The computing units may coordinate between themselves to maintain these shared maps using robust synchronization techniques such as Apache Zookeeper™.

As an example, in FIG. 11 we see that on each computing node, it is possible to know which node any table partition is hosted on, by accessing the “hosting function map” component 1103. For instance, partition 1 of table CUSTOMERS denoted as CUSTOMERS₁ in the Fig. is hosted on node A 1101, while CUSTOMERS₂ and CUSTOMERS₃ are hosted on node B and C respectively 1102.

As shown in FIG. 10, the hosting stage 1006 is applied on a list of tuples <r, id(p_{t,i})>1005 and produces a list of tuples <r, id(p_{t,i}), h(p_{t,i})>1007.

We define the inverse hosting function h′~Q as the function that, given a node n, returns the list of equivalence classes hosted by n, e.g., h′~Q(n)={p_{c,i}, . . . , p_{g,i}}. An equivalence class p_{c,i} belongs to h′~_{Q}(n) if at least one instance of p_{c,i} is hosted on node n. In the following, we will use h′ as short for h′~_{Q}.

In an embodiment, h′ can be implemented by scanning the hosting function map 1103 and grouping its entries by node. For each group, each partition is replaced with the identifier of its equivalence class as described for the partition identifier stage, and duplicates are removed.

### The Grouping Stage

A grouping stage accepts as input a list of tuples <r, id([p_{t,i}]), h(p_{t,i})>and groups them by one or more dimensions. As shown in FIG. 10, the grouping stage X08 is applied on a list of tuples <r, id(p_{t,i}), h(p_{t,i})>1007 and produces a list of tuples <h(p_{t,i}), r, id(p_{t,i})>1009 that are grouped by the node identifier. This last step is necessary to produce the physical partitions that are then transferred to their respective nodes.

In an embodiment, the grouping stage can be implemented on the input data by building a hash table on the node identifier and computing the aggregate values within each group.

Network Optimization Problem when Partitioning Across More than One Data Table

This section describes the network cost optimization problem of the exchange operator for the scenario with partially partitioned tables on the joined key when a relation is composed of more than one data table, which are themselves partitioned into one or multiple data partitions.

When executing the exchange operator of the distributed join “CUSTOMERS x ORDERS”, one naive approach is to broadcast all the records from ORDERS to the computing units hosting the partitions of CUSTOMERS. In this way, each partition of CUSTOMERS will have all the records from ORDERS, and this permits to compute complete and correct join results.

In the scenario of partially partitioned tables, if we consider the join “CUSTOMERS MI ORDERS” and the CUSTOMERS table is partitioned over the joined key “CUSTOMER_ID”, the exchange operator is applied over the relation that is not partitioned on the joined key, i.e., “ORDERS” in the example. Indeed, it is not necessary to broadcast all the records from the right relation to all the partitions of the left relation. The exchange operator consists then in applying the partitioning functions of the relation CUSTOMERS (the partitioned relation) over the relation ORDERS. The specificities of the partitioned relation will therefore dictate the execution of the exchange operator. In fact, for a given record of ORDERS, only the partitions of CUSTOMERS indicated by the partitioning functions can contain possible matches for the join with that record.

The partitioned relation can be either (1) a single data table, e.g., CUSTOMERS; or (2) a view over a data table, e.g., a CUSTOMERS table filtered to a specific region; or (3) a view over several data tables, e.g., a CUSTOMERS relation physically split by region.

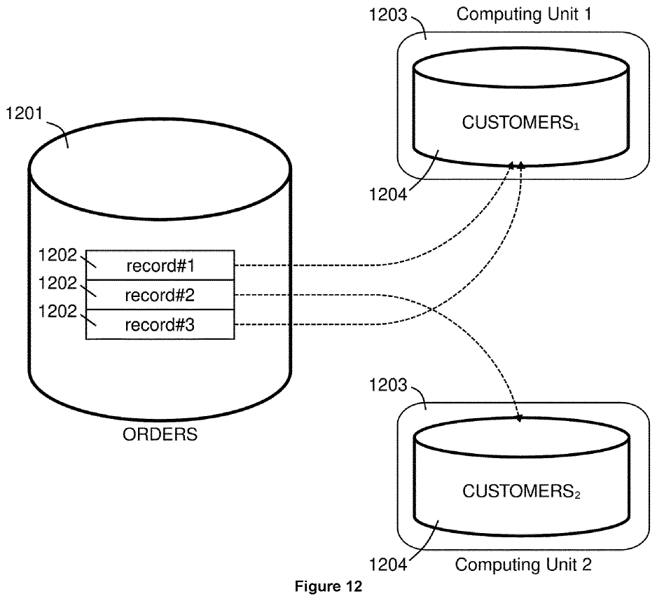

The first two cases are similar given the partitioned relation is composed of a single data table. As depicted in FIG. 12 the partitioning function of CUSTOMERS is applied on the records 1202 of the ORDERS relation 1201. The result of the partitioning function defines the partition 1204 and computing unit 1203 a record 1202 should be sent to. The amount of data transferred across the network is the same as the number of records in the ORDERS relation.

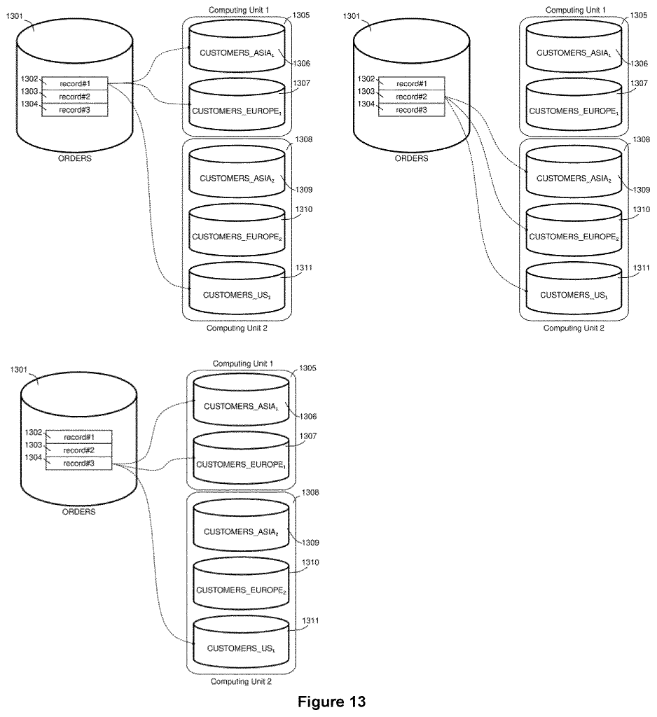

In the third case, each data table of CUSTOMERS has its own partitioning function. A record of ORDERS may have a match in any of the CUSTOMERS data tables. Therefore, each partitioning function of the CUSTOMERS data table must be applied on all records of ORDERS. A consequence is that ORDERS data is duplicated to all data tables of CUSTOMERS. FIG. 13 depicts this case, where all three records of ORDERS 1301 are sent to the three customers tables CUSTOMERS_ASIA, CUSTOMERS_EUROPE, and CUSTOMERS_US. For the sake of readability, the figure is repeated thrice, once per exchanged record. In the example, record #1 1302 is sent to partitions CUSTOMERS_ASIA₁ 1306 and CUSTOMERS_EUROPE₁ 1307 on Computing Unit 1 1305, and to partition CUSTOMER_US1 1311 on Computing Unit 2 1308. record #2 1303 is sent to partitions CUSTOMERS_ASIA₂ 1309, CUSTOMERS_EUROPE₂ 1310, and CUSTOMER_US₁ 1311 on Computing Unit 2 1308. Finally, record #3 1304 is sent to partitions CUSTOMERS_ASIA₁ 1306 and CUSTOMERS_EUROPE₁ 1307 on Computing Unit 1 1305, and to partition CUSTOMER_US1 1311 on Computing Unit 2 1308. This highlights the fact that if the physical location of a partition is not taken into consideration, there can be data duplication. In the following section, we present strategies to avoid, or at least reduce, the amount of duplication.

### Optimizing the Network Cost of the Exchange Operator

This section describes the proposed solution to the network cost optimization problem of the exchange operator for the scenario with partially partitioned tables on the joined key when a relation is composed of more than one data table. In the following description, the input tuples of the exchange operator are ordered by the record due to cross product between the right relation and the left relation.

### Strategy S1

A first strategy S1 is to group tuples per node. FIG. 14 depicts the processing pipeline of such an exchange operator applied on the data from example FIG. 13.

In this example, the grouping stage 1408 groups incoming tuples 1407 on a per node basis and produces a list of tuples grouped per node 1409. Tuples are then transferred to their respective computing nodes 1410.

In an embodiment, the grouping stage 1408 can be done using a hash table on the node identifier. The impact on memory of the hash table is linear with the number of nodes.

This strategy is a simple application of the traditional exchange operator which was described previously, but it has a disadvantage when a relation is partitioned across more than one data table. As shown in example FIG. 13, if a record is mapped to more than one table partition hosted on the same node, then the record is duplicated. For example, amongst the tuples 1411 transferred to the computing unit n₁, the record r₁ and r₃ are duplicated. This may lead to a higher network and memory cost. In an embodiment, compression techniques such as dictionary encoding may be used on the record and partition identifier columns to reduce the size of the data transfer.

### Strategy S2

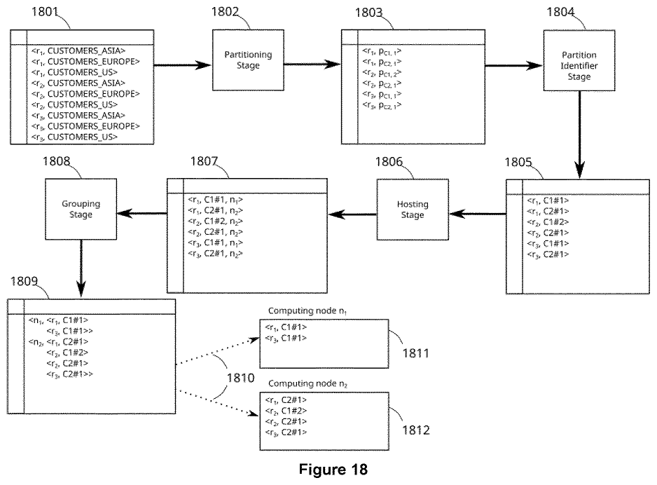

The second strategy S2 is similar to S1, with the difference that it uses the equivalence relation Q between table partitions to map a table partition to a partition of the equivalence class for that table, and therefore reduce the number of duplicate records. FIG. 18 depicts the processing pipeline of such an exchange operator applied on the data from example FIG. 13.

In this example, the partitioning stage 1802 computes a partition p_{t,i} for a record r, maps the partition p_{t,i} to a partition p_{c,i} of the equivalence class c (where c is the equivalence class of t), and removes duplicate records occurring in the partition p_{c,i}.

The partition identifier stage 1804 assigns a unique identifier to each partition p_{c,i}.

The hosting stage 1807 maps a partition identifier to one or more computing unit identifiers. Indeed, the partition p_{c,i} being a set of partitions for several tables, and individual table partitions can be hosted on different computing units. For example, referring back to FIG. 11, it can be seen that PAYMENTS and ORDERS could have the same partition function (they both have two shards) and each shard could be located on a different node.

The grouping stage 1808 groups incoming tuples 1807 on a per node basis and produces a list of tuples grouped per node 1809.

The resulting group of tuples are then transferred 1810 to their respective computing units 1811 and 1812.

The computing unit can then scan the incoming tuples to produce the appropriate table partitions for the local join computation as follows: for each incoming tuple, it maps the partition identifier to a partition p_{c,i}, and finally maps a partition p_{c,i} to one or more table partitions hosted on that node.

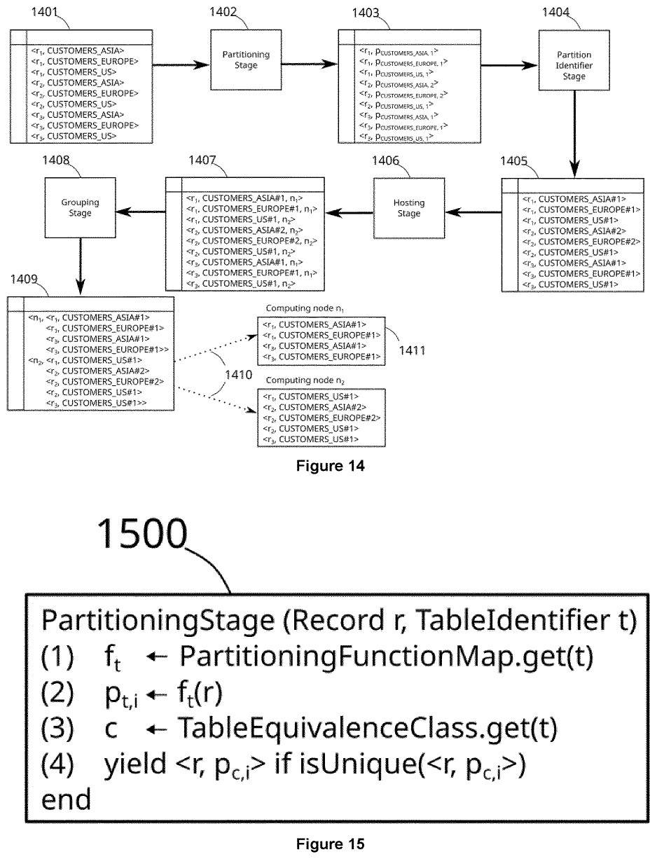

In an embodiment, the partitioning stage 1802 may be implemented as depicted in the pseudocode of FIG. 15, which, given as input a tuple containing a record r and a table t, yields tuples unique on the partition equivalence class. In line (1) of 1500, the table identifier t is mapped to a partitioning function pₜ using the partitioning function map 901 that is stored in the cache storage. In line (2) of 1500, the partitioning function fₜ is applied on the record r and produces a partition p_{t,i} In line (3) of 1500, the table identifier t is mapped to the identifier c of its equivalence class using the table equivalence classes 902 stored in the cache storage. In line (4) 1500, the partition p_{t,i} is mapped to the partition p_{c,i} of the equivalence class c and is returned by the function if and only if the tuple <r, p_{c,i}> was not seen before.

In an embodiment, the function isUnique ( ) may be implemented by using a hash set to store the <r, p_{c,i}> pairs. When isUnique (<r, p_{c,i}>) is called, the function checks if the input is already contained in the hash set. In that case, the function returns ‘false’. Otherwise, <r, p_{c,i}> is added to the hash set and the function returns ‘true’. Since the <r, p_{c,i}> pairs are evaluated in order by record, the hash set can be cleared every time we start evaluating the <r, p_{c,i}> pairs of a different record. The isUnique function keeps track of the previously processed record as part of its state, and checks if it is different from the currently processed one. If the record is the same, nothing needs to be changed. Otherwise, we update the state with the new record and we clear the hash set. Since the r component is implicit from the state of isUnique, the hash set can store just the p_{c,i} partitions to reduce memory footprint.

As an alternative to the FIG. 15 implementation of the partitioning stage, the following could be employed: each record is evaluated in turn, and a cache is updated with the identity of each data table in which the record may occur. Once all data tables are found, these are resolved to identify the table equivalence class or classes corresponding to the data tables. A partitioning function associated with each equivalence class, either that of one of the data tables in the equivalence class or an equivalent partitioning function, is applied to the record for each equivalence class, to map the record to the appropriate partition p_{c,i} of the equivalence class. In cases where records might be found in many data tables of the left relation, this alternative may reduce the number of processing cycles involved in applying multiple equivalent partitioning functions.

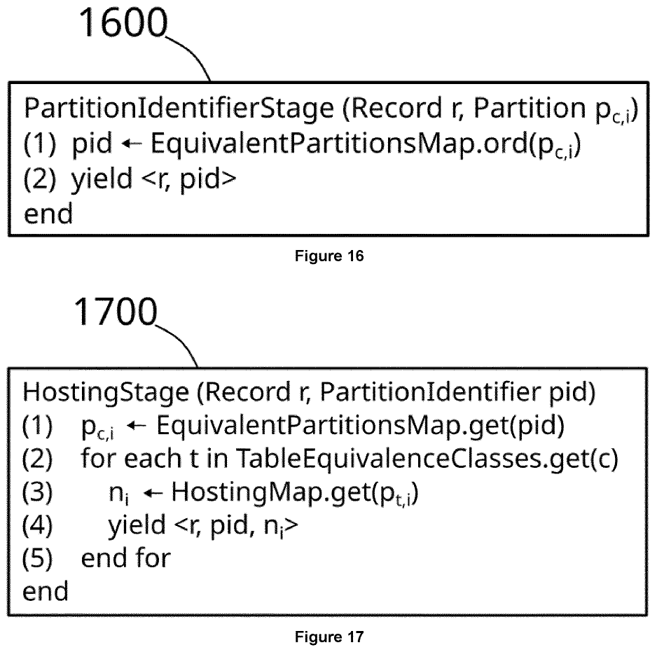

In an embodiment, the partition identifier stage 1804 may be implemented as depicted in the pseudocode of FIG. 16. In line (1) of 1600, the equivalence class partition p_{c,i} is mapped to a partition identifier pid using the equivalent partitions map 905. In line (2) of 1600 a tuple <r, pid> is returned.

The hosting stage 1806 may be implemented as depicted in the pseudocode of FIG. 17. In line (1) of 1700, the partition identifier pid is mapped to the partition p_{c,i} of the equivalence class c using the equivalent partitions map 905. In line (2) of 1700, the class c is mapped to a list of equivalent tables {t₁, . . . , tₙ} using the table equivalence classes 902. In line (3) 1700, the partition p_{c,i} is mapped to a partition p_{t,i} and then mapped to a computing unit identifier using the hosting map 1103 that is stored in the cache storage. In line (4) 1700, a tuple <r, pid, nᵢ> is returned.

Compared to S1, the advantage is that S2 eliminates some of the duplicate records within a computing unit, which reduces the network and memory cost. For example, the resulting group of tuples for the computing unit n₁ does not include duplicates for record r₁ and r₃. Similarly to S1, table partition identifiers may be duplicated across records. In an embodiment, compression techniques such as dictionary encoding may be used on the table partition identifier column to reduce the size of the data transfer.

### Strategy S3

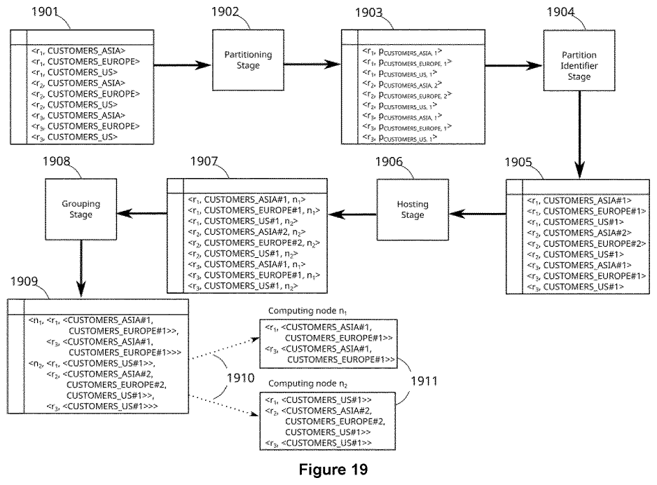

A third strategy S3 is to group the tuples per node and per record. FIG. 19 depicts the processing pipeline of such an exchange operator applied on the data from example FIG. 13.

In this example, the grouping stage 1908 groups incoming tuples 1907 per node then per record 1909. The resulting group of tuples are then transferred 1910 to their respective computing units 1911.

In an embodiment, the grouping stage 1908 can be done using a hash table on the node identifier. The impact on memory of the hash table is linear with the number of nodes. The grouping per record can be performed efficiently without a hash table by performing a linear scan over the tuples, as the list of tuples is already ordered by record.

Compared to S2, the advantage is that the records are not duplicated within a node, which reduces the network and memory cost. Similarly to S2, table partition identifiers may be duplicated across records.

In an embodiment, compression techniques such as dictionary encoding may be used on the table partition identifier column to reduce the size of the data transfer.

In an embodiment, a table partition identifier may be based on an cluster-wide incremental identifier which can then be used to encode more efficiently the table partition identifier across multiple records.

In an embodiment, an incremental identifier may be encoded using a bit set compression technique. In another embodiment, an incremental identifier may be encoded using a variable length compression technique.

### Strategy S4

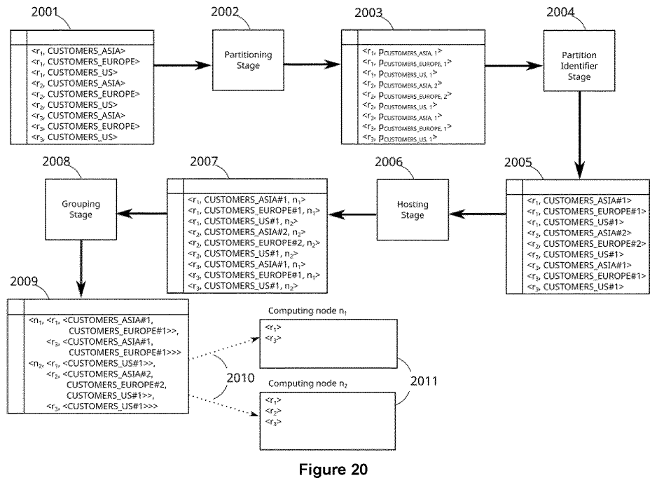

A fourth strategy S4 is to group the tuples per node identifier and per record then drop the associated table partition identifier before transferring the data to a computing unit. FIG. 20 depicts the processing pipeline of such an exchange operator applied on the data from example FIG. 13.

In this example, the grouping stage 2008 groups incoming tuples 2007 on a per node then per record 2009. The table partition identifiers are discarded before being transferred 2010 to their respective computing nodes 2011.

Similar to S3, the advantage is that the records are not duplicated within a node, which reduces the network and memory cost.

Another advantage is that the table partition identifier is not sent through the network, which leads to a lower network cost.

However, this strategy has a disadvantage. Given that the tuples are partitioned on a per node basis, the local join stage does not have information to group tuples per table partition. This means that the local join must be performed with a superset of the tuples. While this does not lead to false positive results due to the partitioning strategy, it leads to a larger CPU and memory cost.

### Strategy S5

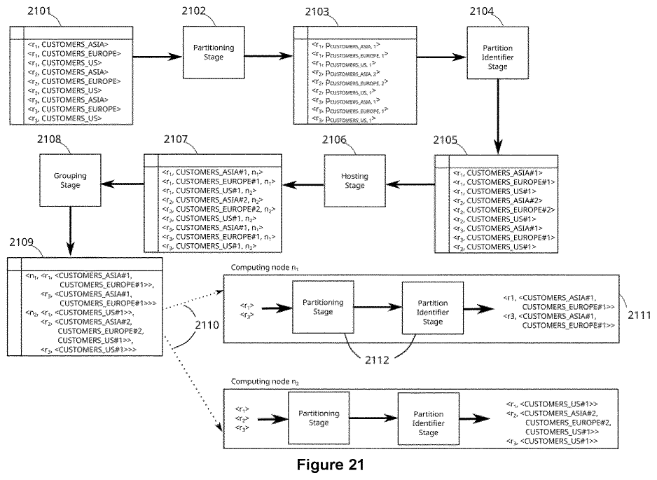

The fifth strategy S5 is similar to S4. But differently from S4, the receiving computing units re-computes the table partitions associated with the received records. FIG. 21 depicts the processing pipeline of such an exchange operator applied on the data from example FIG. 13.

From 2101 to 2109, the processing pipeline behaves exactly like the one in FIG. 20. The table partition identifiers are discarded before being transferred 2110 to its computing node 2111. On each computing node 2111, records are associated again with the table partitions hosted by the computing node 2111.

This is done by locally reproducing the same steps 2112 carried out by the processing pipeline from 2101 to 2103, limitedly to the received records and to the table partitions hosted by the computing unit 2111.

Similar to S4, one advantage of approach S5 is its lower network cost: the records are not duplicated within a node, and the table partition is not sent through the network.

The disadvantage is that S5 has a higher CPU cost than the previous strategies, because the table partition must be re-computed for each record by the receiving computing units. However, compared to approach S4, the local join stage is more cost effective as it can use table partitioning information to reduce the number of comparisons between records.

Another drawback of S5 is that records from the right relation must be uploaded as-is, e.g., they cannot be hashed to further reduce the size of the data transfer (see for example Mokadem, Riad, Abdelkader Hameurlain, and Franck Morvan. “Performance improving of semi-join based join operation through algebraic signatures.” 2008 IEEE International Symposium on Parallel and Distributed Processing with Applications. IEEE, 2008). S5 needs to re-compute the table partition for each record and, for this purpose, the partition key of the record cannot be hashed.

### Strategy S6

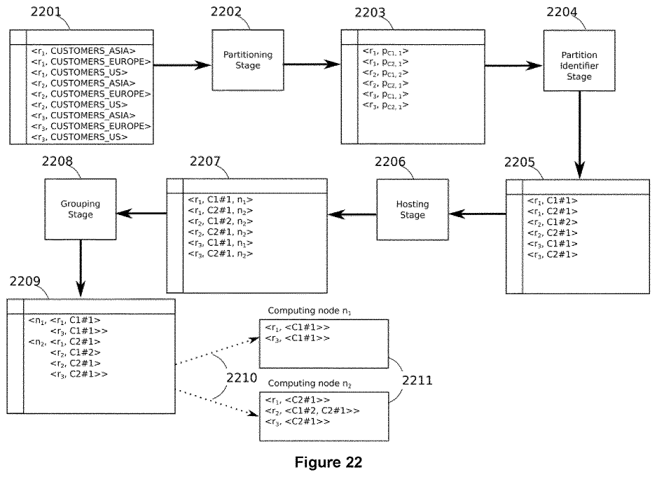

The sixth strategy S6 is similar to S3, with the difference that it uses the equivalence relation Q between table partitions to map a table partition to a partition of the equivalence class for that table. FIG. 22 depicts the processing pipeline of such an exchange operator applied on the data from example FIG. 13.

Starting from a collection of records 2201, the partitioning stage 2202 computes a partition p_{t,i} for a record r, maps the partition p_{t,i} to a partition p_{c,i} of the equivalence class c (where c is the equivalence class of t), and removes duplicate records occurring in the partition p_{c,i}.

The implementation of the partitioning stage 2202 is identical to the one in S2. The output of the stage is a collection of <rⱼ, p_{c,i}>) pairs 2023. This collection is taken as input by the partition identifier stage 2204, which assigns a unique identifier to each partition p_{c,i}. The output of the stage is a collection of record-and-partition identifier pairs 2025.

This collection is taken as input by the hosting stage 2206 which maps a partition identifier to one or more computing unit identifiers. The implementation of the hosting stage 2206 is identical to the one in S2. The output of this stage is a collection of tuples composed of a record, a partition identifier, and a computing node identifier 2207.

The grouping stage 2208 groups incoming tuples 2207 on a per node basis and produces a list of tuples grouped per node then per record 2209.

The resulting group of tuples are then transferred 2210 to their respective computing units 2211. The computing unit 2211 can then scan the incoming tuples to produce the appropriate table partitions for the local join computation as follows: for each incoming tuple, it maps the partition identifier to a partition p_{c,i}, and finally maps a partition p_{c,i} to one or more table partitions hosted on that node.

Compared to S2, it offers better network cost as it removes record duplicates. For example, the resulting group of tuples for the computing unit n₂ does not include duplicates for record r₂.

Compared to S3, this offers better network cost as it reduces the number of partition identifiers associated with a record. For example, the resulting group of tuples for the computing unit n₁ comprises a total of two partition identifiers, one for each record, instead of four in S3. In addition, this may achieve better compression rate given the smaller number of partition identifiers, reducing further the memory cost.

Compared to S4 or S5, it has a higher network, given that it has to transfer a list of partition identifiers associated with a record. However, the impact is minimized given the better compression rate achieved. Although, it offers a better CPU and memory cost given that the tuples include the partition identifiers.

### Cost-Based Optimization of Query Execution Plan

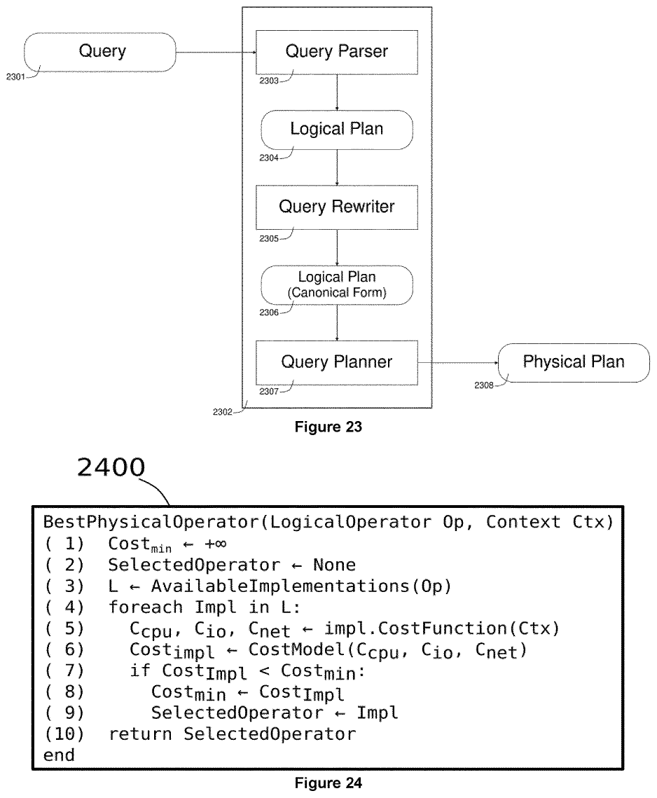

The node coordinator coordinates the execution of a query within the database system. FIG. 23 shows the functioning of an exemplary coordinator.

When a query 2301 is sent to the coordinator 2302, a query parser 2303 parses the query to generate a logical plan 2304. The logical plan is a higher-level representation of the query and its operators.

An optional query rewriter 2305 rewrites and optimizes the logical plan into an equivalent, but simpler, canonical form 2306.

Either the logical plan or the canonical form (if the query rewriter is used) is processed by the query planner 2307 that converts the logical plan into a physical plan 2308. The physical plan defines how the query is processed in practice, e.g., on which computing units a scan operation should be performed on, or which algorithm should be used to perform a join operation.

The logical plan 2304 represents query 2301 in terms of its logical operators and what they do from a logical point of view, e.g., the scan operator scans a data table, the join operator joins the output of two input scans. A logical plan may comprise a plurality of query operators, including but not limited to join, semi-join, filter, scan, etc.

In an embodiment, the logical plan may be represented as a directed acyclic graph of query operators. A query operator may have one or more child query operators, indicating a direct dependency between the parent operator and its children. The output table of a child operator will act as one of the inputs of the parent operator. As previously described, FIG. 2 shows an example query converted into a logical plan (FIG. 3).

For query 2301 to be actually executed, the logical plan 2304 must be translated into a physical plan 2308, where logical operators are mapped to physical operators. A physical operator specifies implementation aspects such as on which computing units a scan operation should be performed, or which algorithm should be used to perform a join. In fact, a join operator can be executed using different algorithms, such as but not limited to hash join or index join.

In general, a logical operator can be translated to different physical operators, which are likely to have different costs. It is the duty of the query planner 2307 to identify which is the most efficient physical operator to implement a logical one, given the context. In the case of a join operator, the context parameters to be considered can be —but are not limited to—the number of computing units in the cluster, the number of data tables, the number of data table partitions, the number of records to be joined.

To select the most efficient physical operator, these must be evaluable under a common cost model. In an embodiment, the cost model can be a linear combination of various cost components such as:
The CPU cost, e.g., the number of computing instructions for creating supporting data structures such as hash tables;
The I/O cost, e.g., the number of I/O operations for reading records; and.
The network cost, e.g., the overall size of records to be uploaded.

Network communication is in general the most time-taking operation in a distributed system: sending data through the wire is slow and therefore takes a significant amount of time. For this reason, it is frequent for the network cost to be the most important component of the cost model.

In order for the planner to select the fastest physical operator among a set of choices, each operator must provide a cost function that returns the cost components needed to evaluate the cost model.

In an embodiment, the selection strategy can be implemented by the planner as shown in FIG. 24. The pseudocode 2400 defines a function that takes as inputs a logical operator Op and an execution context Ctx (e.g., statistics and metadata such as the number of computing units in the cluster, the number of records to be joined, etc.), and returns the best, most efficient, physical operator for Op.

In lines (1-2) of 2400 the function initializes a Costₘᵢₙ variable to an infinitely large value, and a SelectedOperator variable to a null value. The SelectedOperator variable will eventually hold the most efficient physical operator for the input logical operator and context.

In line (3) of 2400, the function retrieves all the possible physical operators which can implement Op.

In an embodiment, this is possible with the planner maintaining a hash table that maps each logical operator to its list of implementing physical operators.

With the loop at line (4) of 2400, each of these physical operators Impl is analyzed: at line (5) of 2400, the CostFunction of Impl is evaluated using context Ctx, to gather the CPU cost c_{cpu}, the IO cost cᵢₒ, and the network cost cₙₑₜ.

At line (6) of 2400 the planner cost model is evaluated using those values, and the cost stored in a Costᵢₘₚₗ variable; if Costᵢₘₚₗ is less than Costₘᵢₙ (line (7) of 2400), Costₘᵢₙ and SelectedOperator are updated (lines (8-9) of 2400). The physical operator with the least cost is eventually returned at line (10) of 2400.

Relatively to this invention, the strategies S1 to S6 described above are physical operators for the logical exchange operator introduced previously in the discussion of FIGS. 2-7.

Our strategies can be selected by the planner to implement a logical exchange for joining partially partitioned tables. Each strategy implements its own cost function, which permits the planner to evaluate them, and select them if they are the most efficient implementation according to the cost model.

For example, consider a R [symbol] S join over partially partitioned tables. Let R be composed by a number |T_{R}| of tables, which are hosted by k different computing units. The logical exchange operator can be implemented by three different physical operators:
An implementation that partitions the records from Rand S over the computing units of the cluster (which we call FD, as in ‘fully distributed’).
An implementation that broadcasts the records from S to all the k computing units hosting R (which we call BR, as in ‘broadcast’).
One of our exchange strategies, S2, that partitions the records from S over the k computing units hosting R

Let |R| (respectively |S|) be the number of records of R (respectively S). If we solely focus on the most important cost component, i.e., the network cost, it can be proved that:
FD has cost |R|+|S|, because all records of both R and S must be exchanged over the whole cluster;
BR has costk×|S|, because every record from S must be broadcasted to every k computing nodes hosting R; and
S2 has cost

$${\sum }_{n = 1}^{k} {\sum }_{{p}_{c , i} ∈ {h}^{′} ( n )} \frac{1}{{d}_{c}} \vert S \vert =.$$

This is because the records from S are selectively transferred only to certain nodes as described in strategy S2. Similar conclusions can be arrived at for the other strategies, according to the number of records that needs to be transferred.

Consider an example where R is a view over three tables CUSTOMERS_ASIA, CUSTOMERS_EUROPE, and CUSTOMERS_US with respectively 4.561×10⁹, 7.464×10⁸, and 3.319×10⁸ rows which are estimates of the population of those geographic areas. Let CUSTOMER_ASIA and CUSTOMER_EUROPE belong to a same equivalence class c₁, and both tables be partitioned onto five partitions each. Let CUSTOMERS_US belong to a different equivalence class c₂, and the table be partitioned onto three partitions. The partitions are hosted by five computing nodes as shown in the following table:

| | Partitions | | |
|---|---|---|---|
| | CUSTOMERS_ASIA | CUSTOMERS_EUROPE | CUSTOMERS_US |
| Node 1 | 1 | 5 | 1 |
| Node 2 | 2 | 4 | |
| Node 3 | 3 | 3 | 2 |
| Node 4 | 4 | 2 | |
| Node 5 | 5 | 1 | 3 |

Let S be a view over a table ORDER with 4.36×10⁸ rows which is an estimate of the daily number of parcels shipped worldwide.

Consider the following example:

$$\vert R \vert = 4.561 \times {10}^{9} + 7.464 \times {10}^{8} + 3.319 \times 1 {0}^{8} = 5.6393 \times 1 {0}^{9} ,$$

$$\vert {T}_{R} \vert = 3 ,$$

$${d}_{c 1} = 5 and {d}_{c 2} = 3 ,$$

$$k = 5.$$

$$\vert S \vert = 4.36 \times {10}^{8} .$$

With these values, it can be seen that:
FD would have cost |R|+[S]=5.6393×10⁹+4.36×10⁸=6.0753×10⁹.
BR would have costk×|S|=5×4.36×10⁸=2.18×10⁹.
S2 would have cost

$${\sum }_{n = 1}^{k} {\sum }_{{p}_{c , i} ∈ {h}^{′} ( n )} \frac{1}{{d}_{c}} \vert S \vert == 4.36 \times {10}^{8} \times ( ( \frac{2}{5} + \frac{1}{3} ) + ( \frac{2}{5} ) + ( \frac{1}{5} + \frac{1}{3} ) + ( \frac{2}{5} ) + ( \frac{2}{5} + \frac{1}{3} ) ) == 1.2208 \times {10}^{9}$$

Under such conditions, the planner would pick S2 to implement a logical exchange operator.

More in general, the best case for S2 is when each computing node only hosts equivalent partitions. On the contrary, the worst case is when every computing node hosts only non-equivalent partitions. It can be proved that |T_{R}|×|S| is an upper bound for the network cost of S2.

In the worst case, S2 has a lower cost than BR ifk<|T_{R}|, i.e., the number of nodes hosting R is greater than the number of tables that compose the relation. In all other cases, S2 has always a cost lower than BR.

In the best case, S2 has a lower cost than FD. In the worst case, S2 still has a cost lower than FD if |T_{R}|−1<|R|/|S|. In other terms, S2 has a smaller cost than FD when R is scattered over relatively few tables and its records are quite more than the records of S.

As we described above, S6 is better than S2 in terms of network cost as it removes duplicate records before they are sent to a computing node. In fact, the network cost formula for S2 can be used as an upper bound for the network cost of S6. As a consequence, if S2 is preferable to BR or FD in terms of network cost, then S6 is preferable too.

With no information about the partitioning of the tables and their hosting, it can still be proved that S6 has a network cost not greater than min (k, |T_{R}|)×|S|. We can use this as another upper bound in lieu of its exact cost.

As a consequence, S6 can reduce the execution cost of R M S compared to BR. This always happens when |T_{R}|<k, i.e., the number of nodes hosting R is greater than the number of tables that compose the relation.

As a consequence, S6 can still reduce the execution cost of R M S compared to FD. This always happens when min (|T_{R}|, k)=1, i.e., R is composed of a single table or is hosted by a single computing unit. This can also happen when min (|T_{R}|, k)−1<|R|/|S|. In other terms, S6 has a smaller cost than FD when R is scattered over relatively few computing units (or over relatively few tables) and its records are quite more than the records of S.

As noted, we have presented strategies other than S2 and S6, and their advantages and disadvantages with respect to one another. This means that our other strategies can be more or less efficient than S2 or S6 depending on the context. As a consequence, they can also be more efficient than standard techniques like FD and BD.

1. A method for partitioning a plurality of data records for a join operation on a join key between a left relation and a right relation in a distributed shared-nothing database environment comprising a plurality of computing instances, wherein:
the left relation comprises a plurality n of data tables {t₁, t₂, . . . tₙ}, each comprising a respective set of records and each being partitioned on the join key according to a respective table partitioning function {fₜ₁, fₜ₂, . . . fₜₙ}, wherein the table partitions are hosted on respective computing instances;
the right relation comprises the plurality of data records r to be partitioned on the join key; and
the method comprising the steps of:
a. sharing between the computing instances a set of equivalence classes {c₁, c₂, . . . cₘ}, each equivalence class comprising a plurality d of equivalence class partitions p_{c,i} where 1≤i≤d and each equivalence class identifying a subset of the plurality n of data tables {t₁, t₂, . . . tₙ} which are partitioned according to equivalent partitioning functions; wherein two partitioning functions fₜ and fᵤ of data tables t and u are equivalent if for each record r, fᵢ(r) assigns the record to a table partition p_{t,i} of tablet with index i and fᵤ(r) assigns the record to a table partition p_{u,j} of table u with index j, where i=j and 1≤i,j≤d; whereby table partition p_{t,i} of table t and table partition p_{u,j} of table u are each mapped to an equivalence class partition p_{c,i} of an equivalence class c∈={c₁, c₂, . . . cₘ} identifying tables t and u;
b. for each record r of the right relation, and each tablet of the left relation in which the record r may appear, mapping the record to a respective equivalence class partition p_{c,i} of the equivalence class c identifying the table t, and removing duplicate instances of records mapped to a given equivalence class partition p_{c,i}, to produce a collection of unique tuples <r, p_{c,i}>;
c. identifying, for each equivalence class partition p_{c,i} identified in one of the tuples <r, p_{c,i}>, one or more associated computing instances hosting the equivalent table partition(s) p_{t,i} of the left relation table(s) t identified in the equivalence class c;
d. grouping the tuples <r, p_{c,i}> by their associated computing instance(s); and
e. sending, to each associated computing instance, the records with which the computing instance is associated, wherein each record is accompanied by an identifier of the or each equivalence class partition to which it has been mapped.

2. The method of claim 1, wherein the grouping step (d) further comprises grouping said equivalence class partitions p_{c,i} per record; and the sending step (e) comprises sending a unique instance of each record, accompanied by an identifier of the or each equivalence class partition to which it has been mapped.

3. The method of claim 1, wherein the sending step (e) comprises sending, for each equivalence class partition to which a record has been mapped, a copy of the record with an identifier of that equivalence class partition.

4. The method of claim 1, further comprising performing a local join operation at each associated computing instance by:
mapping the identifier of an equivalence class partition associated with a received record to one or more equivalent table partitions hosted on the computing instance; and
performing a local join operation between said one or more equivalent table partitions hosted on the computing instance and records of the right relation received by the computing instance in step (e).

5. The method of claim 1, wherein each table of the left relation is identified uniquely in a single equivalence class of the set of equivalence classes.

6. The method of claim 1, further comprising:
maintaining a partitioning functions map which identifies, for each table {t₁, t₂, . . . tₙ} of the left relation, the respective table partitioning function {_{ft1}, fₜ₂, . . . fₜₙ}; and
sharing said partitioning functions map across the computing instances.

7. The method of claim 6, further comprising:
generating said equivalence classes by identifying equivalent table partitioning functions in the partitioning functions map and grouping together in an equivalence class each table having equivalent table partitioning functions.

8. The method of claim 1, further comprising:
maintaining an equivalent partitions map which identifies, for each equivalence class, the equivalence class partitions of that class; and
sharing said equivalent partitions map across the computing instances.

9. The method of claim 8, wherein the identifier of the or each equivalence class partition sent to the computing instances in step (e) points to an entry in the equivalent partitions map.

10. The method of claim 1, wherein:
each associated computing instance receiving a record as a result of step (e) identifies the hosted table partitions p_{t,i} of the left relation in which the record may be located by:
determining from the received identifier(s) of each equivalence class partition p_{c,i} the associated data tables of the equivalence class c to which the equivalence class partition p_{c,i} belongs; and
identifying for each associated data table the table partitions p_{c,i} having a one-to-one correspondence with the equivalence class partition p_{c,i}.

11. The method of claim 1, further comprising:
maintaining a hosting function map which identifies, for each table partition, the or each associated computing instance hosting that table partition; and
sharing said hosting function map across the computing instances.

12. The method according to claim 11, wherein the identifying step (c) comprises:
identifying, for each equivalence class partition p_{c,i} identified in one of the tuples <r, p_{c,i}>, the equivalent table partition(s) p_{t,i} of the left relation table(s) t identified in the equivalence class c; and
determining, from the hosting function map, the or each associated computing instance hosting that table partition.

13. The method of claim 1, wherein step (b) comprises:
for each record r of the right relation, and each data table t of the left relation in which the record r may appear, applying the partitioning function record fₜ of the data table t to assign the record to a table partition p_{t,i} of the data table t; and
determining, from the equivalence class c to which the data table t belongs, a corresponding equivalence class partition p_{c,i}.

14. The method of claim 1, wherein step (b) comprises:
for each record r, caching an identification of the data tables in which the record may appear;
identifying a set of equivalence classes covering each data table in which the record may appear;
for each equivalence class in said set, applying a partitioning function which is equivalent to or identical to the partitioning function of one of the data tables of that equivalence class; and
determining a corresponding equivalence class partition p_{c,i}.

15. The method of claim 1, wherein one or more of steps (b), (c), (d) and (e) are performed in batched operations, handling a plurality of records per step at one time.

16. A distributed computing system providing a distributed shared-nothing database environment, comprising:
a plurality of computing instances connected over a network, at least some of which host data records of a left relation and a right relation of a database, wherein:
the left relation comprises a plurality n of data tables {t₁, t₂, . . . tₙ}, each comprising a respective set of records and each being partitioned on a join key according to a respective table partitioning function {fₜ₁, fₜ₂, . . . fₜₙ}, wherein the table partitions are hosted on respective ones of said computing instances;
the right relation comprises a plurality of data records r to be partitioned on the join key; and
said computing instances are programmed to co-operatively perform a method for partitioning the plurality of data records r for a join operation on the join key between said left relation and said right relation, comprising:
a. sharing between the computing instances a set of equivalence classes {c₁, c₂, . . . cₘ}, each equivalence class comprising a plurality d of equivalence class partitions p_{c,i} where 1≤i≤d and each equivalence class identifying a subset of the plurality n of data tables {t₁, t₂, . . . tₙ} which are partitioned according to equivalent partitioning functions; wherein two partitioning functions fₜ and fᵤ of data tables t and u are equivalent if for each record r, fₜ(r) assigns the record to a table partition p_{t,i} of table t with index i and fᵤ(r) assigns the record to a table partition p_{u,j} of table u with index j, where i=j and 1≤i,j≤d; whereby table partition p_{t,i} of table t and table partition p_{u,j} of table u are each mapped to an equivalence class partition p_{c,i} of an equivalence class c ∈ {c₁, c₂, . . . cₘ} identifying tables t and u;
b. for each record r of the right relation, and each tablet of the left relation in which the record r may appear, mapping the record to a respective equivalence class partition p_{c,i} of the equivalence class c identifying the table t, and removing duplicate instances of records mapped to a given equivalence class partition p_{c,i}, to produce a collection of unique tuples <r, p_{c,i}>;
c. identifying, for each equivalence class partition p_{c,i} identified in one of the tuples <r, p_{c,i}>, one or more associated computing instances hosting the equivalent table partition(s) p_{t,j} of the left relation table(s) t identified in the equivalence class c;
d. grouping the tuples <r, p_{c,i}; > by their associated computing instance(s); and
e. sending, to each associated computing instance, the records with which the computing instance is associated, wherein each record is accompanied by an identifier of the or each equivalence class partition to which it has been mapped.

17. A computer program product comprising instructions for execution by one or more computing instances of a distributed computing system providing a distributed shared-nothing database environment, in which:
a plurality of said computing instances are connected over a network, at least some of which host data records of a left relation and a right relation of a database, wherein:
the left relation comprises a plurality n of data tables {t₁, t₂, . . . tₙ}, each comprising a respective set of records and each being partitioned on a join key according to a respective table partitioning function {fₜ₁, fₜ₂, . . . fₜₙ}, wherein the table partitions are hosted on respective ones of said computing instances; and
the right relation comprises a plurality of data records r to be partitioned on the join key;
wherein said instructions when executed by one or more of said computing instances cause said computing instances to co-operatively perform a method for partitioning the plurality of data records r for a join operation on the join key between said left relation and said right relation, comprising:
a. sharing between the computing instances a set of equivalence classes {c₁, c₂, . . . cₘ}, each equivalence class comprising a plurality d of equivalence class partitions p_{c,i} where 1≤i≤d and each equivalence class identifying a subset of the plurality n of data tables {t₁, t₂ . . . tₙ} which are partitioned according to equivalent partitioning functions; wherein two partitioning functions fₜ and fᵤ of data tables t and u are equivalent if for each record r, fₜ(r) assigns the record to a table partition p_{t,i} of table t with index i and fᵤ(r) assigns the record to a table partition p_{u,i} of table u with index j, where i=j and 1≤i,j≤d; whereby table partition p_{t,i} of table t and table partition p_{u,i} of table u are each mapped to an equivalence class partition p; of an equivalence class c=∈{c₁, c₂, . . . cₘ)} identifying tables t and u;
b. for each record r of the right relation, and each tablet of the left relation in which the record r may appear, mapping the record to a respective equivalence class partition p_{c,i} of the equivalence class c identifying the table t, and removing duplicate instances of records mapped to a given equivalence class partition p_{c,i} to produce a collection of unique tuples <r, p_{c,i}>;
c. identifying, for each equivalence class partition p_{c,i} identified in one of the tuples <r, p_{c,i}>, one or more associated computing instances hosting the equivalent table partition(s) p_{t,i} of the left relation table(s) t identified in the equivalence class c;
d. grouping the tuples <r, p_{c,i}> by their associated computing instance(s); and
e. sending, to each associated computing instance, the records with which the computing instance is associated, wherein each record is accompanied by an identifier of the or each equivalence class partition to which it has been mapped.
